(19) United States
(12) Patent Application Publication
(10) Pub. No.: US 2018/0184672 A1
(43) Pub. Date: Jul. 5, 2018

(54) MULTI-FEATURE PATTY PRESS

(71) Applicant: BLUE SKY INNOVATION GROUP, INC., Avon, OH (US)

(72) Inventor: Jeffrey W. Palese, North Ridgeville, OH (US)

(21) Appl. No.: 15/856,187

(22) Filed: Dec. 28, 2017

Related U.S. Application Data
(60) Provisional application No. 62/440,420, filed on Dec. 30, 2016.

(51) Int. Cl. A22C 7/00

(52) U.S. Cl. CPC A22C 7/0076; A22C 7/0046

(57) ABSTRACT

An apparatus for forming patties from a food product includes a base comprising a cylindrical sidewall defining chamber configured to receive the food product. A paddle includes a paddle blade configured to be installed onto the base to form a bottom wall of the chamber, the paddle further comprising a handle positioned outside the base that can be grasped to remove the paddle from the base. A cover is pivotally attached to the base and can be maneuvered from an open condition providing access to the chamber to a closed condition closing the chamber. The cover when in the closed condition is configured to compress the food product in the chamber and cause the food product to conform to the shape of the chamber to form a patty. The paddle is configured to remove the patty formed in the chamber.

### RELATED APPLICATION

This application claims the benefit of U.S. Provisional Application Ser. No. 62/440,420, which was filed on Dec. 30, 2016, the disclosure of which is hereby incorporated by reference in its entirety.

### TECHNICAL FIELD

This invention relates to an apparatus for pressing ground meat into patties of various sizes.

### BACKGROUND OF THE INVENTION

Ground meat patties, such as hamburgers, are popular food items. It can be desirable to form these patties with a consistent shape, size and weight. This consistency cannot be achieved easily when forming patties by hand, as is often the case.

### SUMMARY

The patty press of according to the invention provides a means by which to form ground meat patties with consistent sizes, shapes, and weights.

According to one aspect, an apparatus for forming patties from a food product includes a base comprising a cylindrical sidewall defining chamber configured to receive the food product. A paddle includes a paddle blade configured to be installed onto the base to form a bottom wall of the chamber, the paddle further comprising a handle positioned outside the base that can be grasped to remove the paddle from the base. A cover is pivotally attached to the base and can be maneuvered from an open condition providing access to the chamber to a closed condition closing the chamber. The cover when in the closed condition is configured to compress the food product in the chamber and cause the food product to conform to the shape of the chamber to form a patty. The paddle is configured to remove the patty formed in the chamber.

According to another aspect, an insert can be configured to be installed on the base. The insert can have a first side comprising a first patty mold and an opposite second side comprising a second patty mold. The insert can be configured to be installed on the base with either the first side or second side facing up. The cover when closed can compress the food product on the insert to conform to the shape of the first or second mold, whichever is facing up.

According to another aspect, the first mold can be configured to form a patty that is smaller than a patty formed in the chamber. The second mold can be configured to form a patty that is smaller than a patty formed in the first mold.

According to another aspect, the chamber can be configured to produce ¾ pound beef patties and the first mold can be configured to form ½ pound beef patties.

According to another aspect, a handle assembly can be connected to the cover. The handle assembly can be removable from the cover and can include a base and a handle portion. The base can include a projection that projects from a bottom surface of the handle base and is configured to impress a cavity in a formed patty for receiving a stuffing food.

### BRIEF DESCRIPTION OF THE DRAWINGS

For a better understanding of the invention, reference may be made to the accompanying drawings.

FIG. 1 is perspective view illustrating an example configuration of an apparatus for forming patties, illustrating the apparatus in a closed condition.

FIG. 2 is a perspective view of the apparatus of FIG. 1 in an open condition.

FIG. 3 is an exploded perspective view of the apparatus of FIG. 1 illustrating different patty pressing configurations of the apparatus.

FIG. 4 is a perspective view of a certain component of the patty forming apparatus.

### DESCRIPTION OF EMBODIMENTS

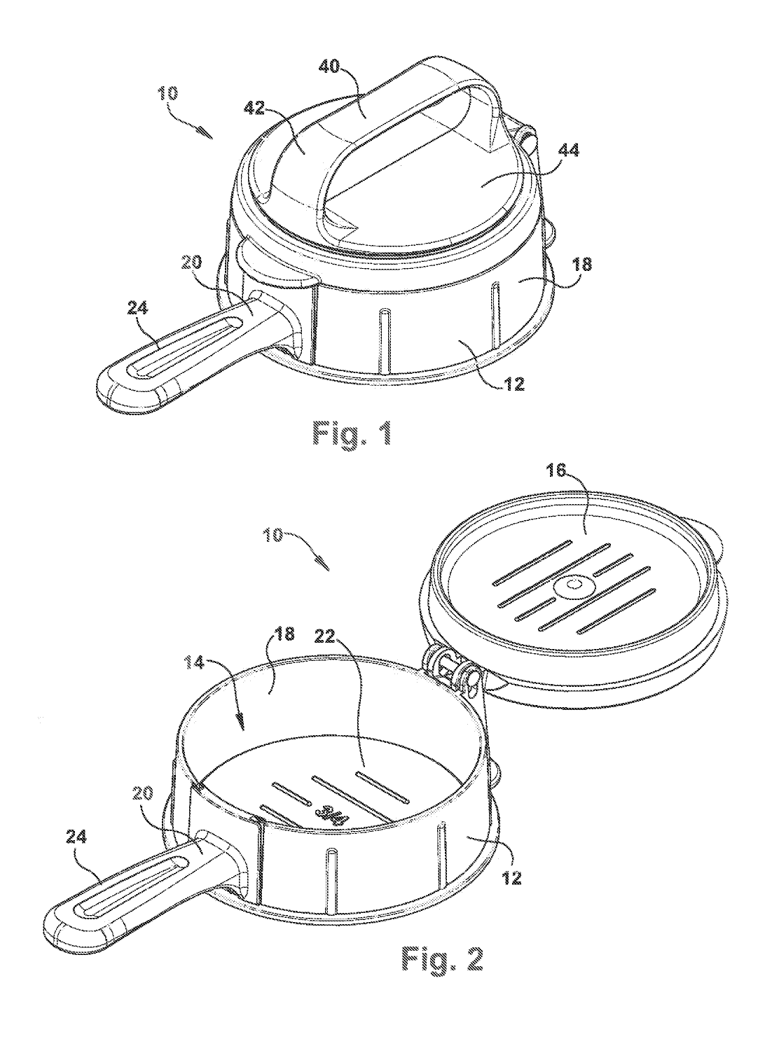

Referring to FIGS. 1 and 2, according to an example configuration of the invention, an apparatus 10 for forming patties from a food product, such as ground meat, includes a base 12 including a cylindrical side wall 18 that defines a cylindrical chamber 14 for receiving the food product. A cover 16 is hinged to the base 12 and maneuverable from an open condition (FIG. 2) to a closed condition (FIG. 1). In the closed condition, the cover 16 closes the chamber 14 and compresses the meat product in the chamber so that the meat assumes the flat, cylindrical, patty-shaped configuration of the closed chamber.

The patty forming apparatus 10 also includes a paddle 20 that is connectable to the base 12. The paddle 20 includes a planar circular paddle blade 22 that is positioned at the bottom of the base 12 and forms the bottom surface of the chamber 14. The paddle 20 also includes a handle 24 that permits the user to install and remove the paddle from the base 12. When the paddle 20 is installed in the base 12 and the cover 16 is closed, the chamber 14 is configured and dimensioned to form a beef patty that is about ¾ of a pound in weight. Conveniently, the paddle blade 22 includes indicia that identifies “¾” so that the user knows the size/weight of the patty (made of ground beef) being produced.

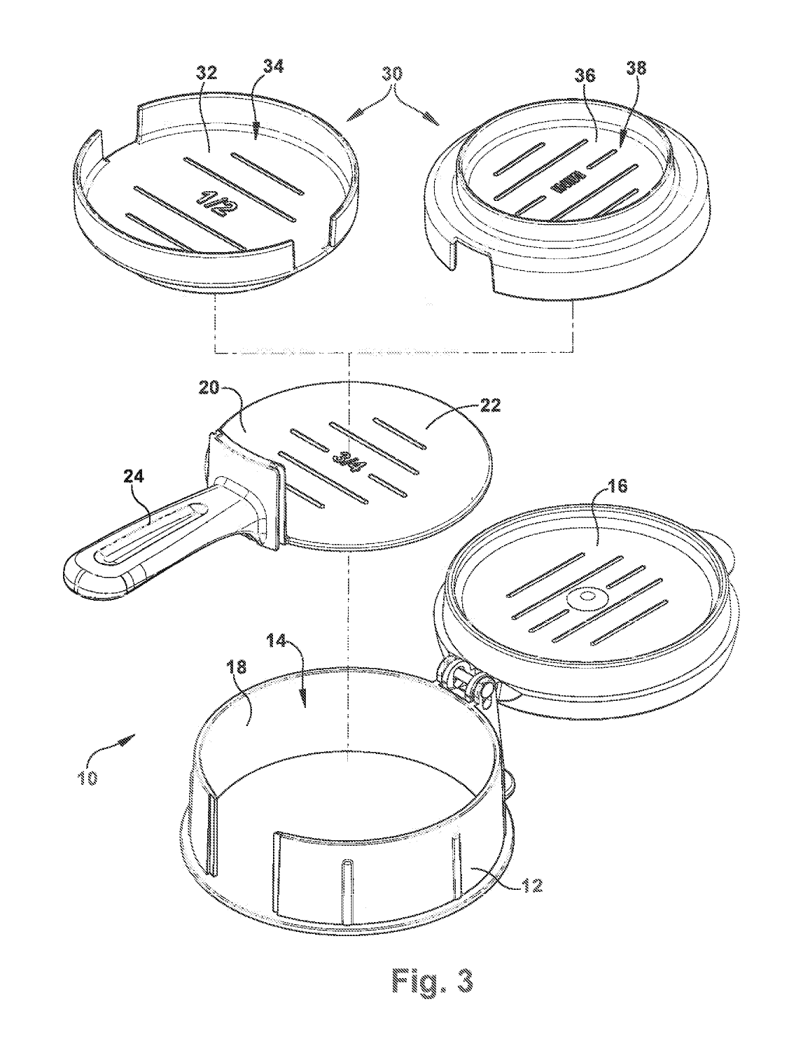

Referring to FIG. 3, the patty forming apparatus 10 also includes a patty forming insert 30 that can be installed in the base 12 on top of the paddle 20. As shown in FIG. 3, the patty forming insert 30 is a two-sided insert that can be installed on the base 12 with either side facing up. A first side 32 of the insert 30 includes a cylindrical mold 34 for forming a ½ pound patty (ground beef). A second side 36 of the insert 30 includes a cylindrical mold 38 for forming a mini patty.

When the patty forming insert 30 is installed in the base 12 with the first side 32 facing up and the cover 16 is closed, the first mold 34 is configured and dimensioned to form a beef patty that is about ½ of a pound in weight. Conveniently, the first side 32 of the insert 30 includes indicia that identifies “½” so that the user knows the size/weight of the patty being produced.

When the patty forming insert 30 is installed in the base 12 with the second side 36 facing up and the cover 16 is closed, the second mold 38 is configured and dimensioned to form a mini beef patty, sometimes referred to as a “slider.” Conveniently, the second side 36 of the insert 30 includes indicia that identifies “mini” so that the user knows the size/weight of the patty being produced.

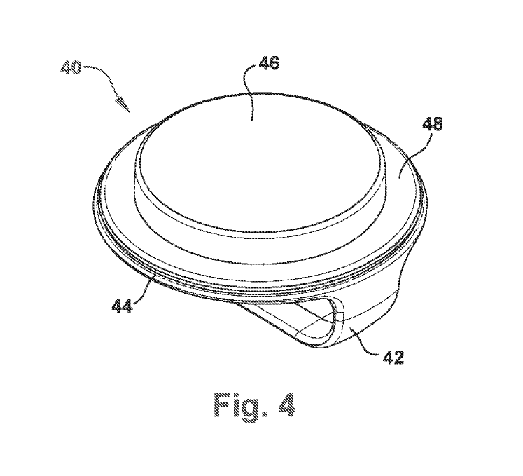

Referring to FIGS. 1 and 4, the cover 16 includes a handle assembly 40 that is removable from the cover. The handle assembly 40 includes a handle 42 and a base 44. The base 44 includes a cylindrical projection 46 that projects form a lower surface 48 of the base. Grasping the handle 42, the user can use the projection 46 to form a recess in a patty, e.g., a ¾ pound patty, formed using the apparatus 10. The recess formed by the projection can be filled with a stuffing food, such as peppers, onions, bacon, cheese, etc.

While aspects of the present invention have been particularly shown and described with reference to the preferred embodiment above, it will be understood by those of ordinary skill in the art that various additional embodiments may be contemplated without departing from the spirit and scope of the present invention. Other aspects, objects, and advantages of the present invention can be obtained from a study of the drawings, the disclosure, and the appended claims.

Having described the invention, we claim:

1. An apparatus for forming patties from a food product, comprising:
a base comprising a cylindrical sidewall defining chamber configured to receive the food product;
a paddle comprising a paddle blade configured to be installed onto the base to form a bottom wall of the chamber, the paddle further comprising a handle positioned outside the base that can be grasped to remove the paddle from the base; and
a cover that is pivotally attached to the base and that can be maneuvered from an open condition providing access to the chamber to a closed condition closing the chamber;
wherein the cover when in the closed condition is configured to compress the food product in the chamber and cause the food product to conform to the shape of the chamber to form a patty, and wherein the paddle is configured to remove the patty formed in the chamber.

2. The apparatus recited in claim 1, further comprising an insert configured to be installed on the base, the insert having a first side comprising a first patty mold and an opposite second side comprising a second patty mold, wherein the insert is configured to be installed on the base with either the first side or second side facing up, and wherein the cover when closed compresses the food product on the insert to conform to the shape of the first or second mold, whichever is facing up.

3. The apparatus recited in claim 2, wherein the first mold is configured to form a patty that is smaller than a patty formed in the chamber, and wherein the second mold is configured to form a patty that is smaller than a patty formed in the first mold.

4. The apparatus recited in claim 3, wherein the chamber is configured to produce ¾ pound beef patties and the first mold is configured to form ½ pound beef patties.

5. The apparatus recited in claim 1, further comprising a handle assembly connected to the cover, the handle assembly being removable from the cover and comprising a base and a handle portion, the base comprising a projection that projects from a bottom surface of the handle base and is configured to impress a cavity in a formed patty for receiving a stuffing food.
